(19) United States
(12) Patent Application Publication
(10) Pub. No.: US 2023/0354996 A1
(43) Pub. Date: Nov. 9, 2023

(54) MODULAR SYSTEM

(71) Applicant: MODULE INCORPORATED LTD, Brentford (GB)

(72) Inventor: Asif Rafiq, London (GB)

(21) Appl. No.: 18/021,817

(22) PCT Filed: Sep. 3, 2021
(86) PCT No.: PCT/EP2021/074410

§ 371 Date: Feb. 17, 2023

(30) Foreign Application Priority Data
Sep. 3, 2020 (GB) 2013830.1

(51) Int. Cl. A47B 87/00; A47B 87/02; A47B 95/00; A47B 96/20; A47B 47/00

(52) U.S. Cl. CPC A47B 47/0091; A47B 47/0041; A47B 87/005; A47B 87/007; A47B 87/0276; A47B 95/008; A47B 96/201; A47B 2230/0059

(57) ABSTRACT

The present disclosure provides a modular system comprising standardised sets of parts including tile elements (304) and connector elements (314) which can be assembled together simply and quickly to build a secure and completely customised storage solution or, for larger version of the disclosed system parts, furniture solution, according to the needs of the user. The system allows for effectively infinite variations while maintaining simplicity of design and easy of both assembly and disassembly.

### CROSS-REFERENCE TO RELATED APPLICATIONS

The present application claims the benefit and priority of UK national application no. GB2013830.1 filed 03 Sep. 2020, the contents of which is incorporated by reference.

### FIELD OF INVENTION

The present invention relates generally to modular building systems. More specifically, the present invention relates to a modular kit for constructing custom furniture or storage solutions.

### BACKGROUND

Modular storage systems are growing in popularity, however the solutions presently available on the market suffer from being time-consuming and difficult for the user to assemble and, especially, to disassemble. The versatility of currently available designs is also limited, with the “modularity” often only allowing partial customization.

Flat-packed furniture has also grown in popularity in recent years, but suffers the same issues with assembly and disassembly in particular proving inconvenient and time consuming, and there is no widely available solution that allows users complete agency over the shape and structure of the built furniture or storage solution.

It is within this context that the present invention is provided.

### SUMMARY

The present disclosure provides a modular system comprising standardised sets of parts including tile elements and connector elements which can be assembled together simply and quickly to build a secure and completely customised storage solution or, for larger versions of the disclosed system parts, furniture solution, according to the needs of the user. The system allows for effectively infinite variations while maintaining simplicity of design and ease of both assembly and disassembly making it environmentally friendly.

Thus, according to one aspect of the present disclosure there is provided a modular system for constructing storage solutions and/or furniture, the system comprising: two or more tile elements, each tile element forming a flat panel having four edges of a first length, wherein each edge of each tile element has disposed thereon a linear connector cavity running parallel to the edge, each cavity spanning a second length equal to a portion of the first length and having a first depth.

The system further comprises one or more connector elements, each connector element being formed of a square rod having a length equal to the first length, wherein each connector element has disposed on one or more of the four faces spanning the length of the square rod a protrusion extending perpendicularly to the face, the protrusion spanning a portion of the square rod equal to the second length and extending a distance from the face equal to the first depth.

It should be noted that for each square rod profile, each face/side of the rod should be of a length equal to the thickness of the edges of the tile elements to provide a tight fit when assembled together. This applies to square rod profiles of all the different connector elements disclosed below.

In some embodiments, the system further comprises: one or more door elements, each door element forming a flat panel having four edges of length equal or less than to the first length, wherein each door element has at least one edge with no connector cavity disposed thereon, and has a hinge protrusion and/or hinge cavity disposed at the end of each edge that is adjacent to the edge having no connector cavity; and one or more door connector elements, each door connector element being formed of a square rod having a length equal to the first length, wherein each door connector element has disposed on between one and three of the four faces spanning the length of the square rod a protrusion extending perpendicularly to the face, the protrusion spanning a portion of the rod equal to the second length and extending a distance from the face equal to the first depth, a fourth face of each door connector element having disposed at one end thereof a hinge protrusion and/or hinge cavity configured to from a hinge joint with the hinge cavity or hinge protrusion of a corresponding door element.

In such embodiments, the one or more door elements may further comprise a handle or grip disposed on a planar face of the door element.

In such embodiments, the one or more door elements and one or more corresponding connector elements may comprise corresponding latch or locking mechanisms.

In such embodiments, each door element and door connector element may comprise both a hinge protrusion on one edge and hinge cavity on an opposing face.

In such embodiments, each door element may comprise between one and three edges having disposed thereon a linear connector cavity running parallel to the edge, each cavity spanning a length equal to the second length and having depth equal to the first depth.

In some embodiments, the system further comprises one or more leg connector elements, one or more of the leg connector elements being formed of a square rod having a length greater than the first length and having disposed on one of the four faces spanning the length of the square rod a protrusion extending perpendicularly to the face, the protrusion spanning a portion of the rod equal to the second length and extending a distance from the face equal to the first depth.

In some embodiments, the system further comprises one or more leg connector elements, one or more of the leg connector elements being formed of a square rod having a length equal to or greater than the first length and having disposed on two adjacent faces of the four faces spanning the length of the square rod a protrusion extending perpendicularly to the face, each protrusion spanning a portion of the rod equal to the second length and extending a distance from the face equal to the first depth.

In some embodiments, the system further comprises one or more leg connector elements, one or more of the leg connector elements being formed of a square rod having a length equal to or greater than the first length and having disposed on two adjacent faces of the four faces spanning the length of the square rod a protrusion extending perpendicularly to the face, each protrusion spanning a portion of the rod equal to the second length and extending a distance from the face equal to the first depth, and further comprising two or more leg supports disposed on a third face of the four faces.

In some embodiments, the system further comprises one or more wall bracket connector elements, each top bracket connector element being formed of: an outer bracket having a length equal to or greater than the first length and having a supporting shelf and a back wall together forming an angled L-shaped profile, the back wall comprising one or more openings for securing the outer bracket to a wall; and an inner bracket having a length less than or equal to the length of the outer bracket and a quadrilateral profile having an angled indent configured to interlock with the L-shaped profile via the angled supporting of the outer bracket, each inner bracket having disposed on between one and three of the four faces spanning the length of the inner bracket a protrusion extending perpendicularly to the face, the protrusion spanning a portion of the inner bracket equal to the second length and extending a distance from the face equal to the first depth.

When assembled together, the inner bracket and outer bracket preferably from a square profile with each face/side being of a length equal to the thickness of the edges of the tile elements to provide a tight fit when assembled together as above.

In some embodiments, the system further comprises a locking mechanism for securing the modular elements together, the locking mechanism comprising: one or more first openings disposed on the one or more protrusions of the connector elements; one or more second openings disposed at corresponding positions of the one or more tile elements so as to overlap with the one or more first openings when the connector elements are inserted in the cavities of the tile elements, the one or more second openings each having a corresponding rubber or plastic receiving element disposed therein; and one or more rubber or plastic locking elements configured to interlock with the receiving elements and protrude through both the first and second openings of a connection between a connector element and tile element so as to lock the pieces in place.

In such embodiments, the rubber or plastic receiving elements may each comprise a groove running about the length of an inner surface and the one or more rubber or plastic locking elements may each comprise a corresponding ridge about the circumference of an outer surface and configured to lock with the grooves.

In such embodiments, the system may further comprise an installation and disassembly tool comprising a handle and a threaded end; and wherein each plastic locking element comprises a threaded cavity configured to interlock with the threaded end of the installation and disassembly tool.

In some embodiments, one or more of the tile elements and one or more of the connector elements are formed of one or more of: wood, ply, plastic, or a metal such as aluminium.

According to another aspect of the present disclosure there is provided a method of use of the modular storage system of any one of the above-described embodiments for constructing custom storage solutions.

According to another aspect of the present disclosure there is provided a method of use of the modular storage system of any one of the above-described embodiments for constructing custom furniture solutions.

### BRIEF DESCRIPTION OF THE DRAWINGS

Various embodiments of the invention are disclosed in the following detailed description and accompanying drawings.

FIG. 1A illustrates an isometric view of a first example configuration of a storage system constructed from components of the disclosed system.

FIG. 1B illustrates an isometric view of a second example configuration of a storage system constructed from components of the disclosed system.

FIG. 1C illustrates an isometric view of a third example configuration of a storage system constructed from components of the disclosed system.

FIG. 1D illustrates an isometric view of a fourth example configuration of a storage system constructed from components of the disclosed system.

FIG. 2A illustrates an isometric view of an example configuration of a tile element of a storage or furniture assembly constructed from components of the disclosed system.

FIG. 2B illustrates an isometric view of a first example configuration of a connector element component of the disclosed system.

FIG. 2C illustrates an isometric view of a second example configuration of a connector element component of the disclosed system.

FIG. 2D illustrates an isometric view of a third example configuration of a connector element component of the disclosed system.

FIG. 2E illustrates an isometric view of a fourth example configuration of a connector element component of the disclosed system.

FIG. 3A illustrates an isometric view of an example configuration of a door element component of the disclosed system.

FIG. 3B illustrates an isometric view of an example configuration of an upper door mount connector element of the disclosed system.

FIG. 3C illustrates an isometric view of an example configuration of a lower door mount connector element of the disclosed system.

FIG. 3D illustrates an isometric view of an example configuration of a connector element component extending the door element component of the disclosed system.

FIG. 3E illustrates an isometric view of an example configuration of an upper door mount connector element, middle connector element, and lower door mount connector element arranged to support an extended door element.

FIG. 4A illustrates an isometric view of a first example configuration of a support leg connector element component of the disclosed system.

FIG. 4B illustrates an isometric view of a second example configuration of a support leg connector element component of the disclosed system.

FIG. 4C illustrates an isometric view of a third example configuration of a support leg connector element component of the disclosed system.

FIG. 4D illustrates an isometric view of a fourth example configuration of a support leg connector element component of the disclosed system.

FIG. 5A illustrates a cross-sectional view of an example configuration of a two-part top bracket connector element of the disclosed system installed on a wall.

FIG. 5B illustrates an isometric view of the example configuration of the two-part top bracket connector element of the disclosed system.

FIG. 5C illustrates an isometric view of an example configuration of a two-part bottom bracket connector element of the disclosed system.

FIG. 5D illustrates an isometric view of an example configuration of an outer bracket part of the two-part bracket connector element of the disclosed system.

FIG. 5E illustrates a first isometric view of an example configuration of an inner bracket part of the two-part top bracket connector element of the disclosed system.

FIG. 5F illustrates a second isometric view of the example configuration of an inner bracket part of the two-part top bracket connector element of the disclosed system.

FIG. 5G illustrates an isometric view of an example configuration of an inner bracket part of the two-part bottom bracket connector element of the disclosed system.

FIG. 5G illustrates an isometric view of an example configuration of an inner bracket part of the two-part bottom bracket connector element of the disclosed system.

FIG. 6A illustrates an isometric view of an example configuration of a receiving element of a locking mechanism of the disclosed system.

FIG. 6B illustrates an isometric view of an example configuration of a locking element of a locking mechanism of the disclosed system.

FIG. 6C illustrates an isometric view of an example configuration of an installation and disassembly tool for allowing a user to operate a locking mechanism of the disclosed system.

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### DETAILED DESCRIPTION AND PREFERRED EMBODIMENT

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

The terminology used herein is for the purpose of describing particular embodiments only and is not intended to be limiting of the invention. As used herein, the term “and/or” includes any combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The present disclosure provides a kit comprising sets of tile elements, connector elements, and various other supporting elements which together can quickly and intuitively be assembled together to from a desired structure.

The size of the parts in a given system is standardised to improve the modularity, but can be varied between sets/systems to allow for different scales of assembly. Smaller parts may be used to build customised storage solutions, while larger parts may be suitable for creating custom furniture or any other structure (e.g outside structures/sheds/out-houses).

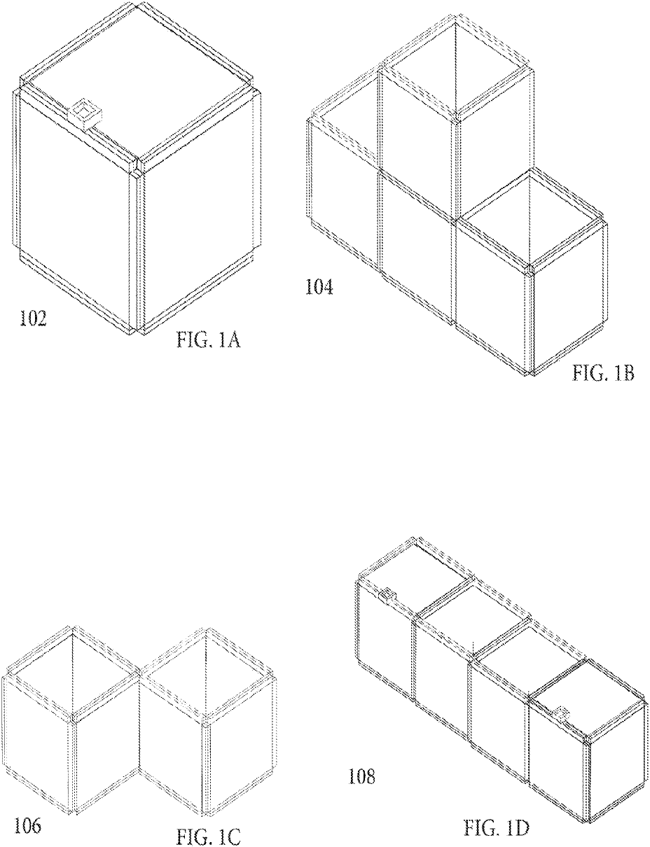

Referring to FIG. 1A–FIG. 1D, some simple example designs for different storage solutions built using elements of the disclosed system are shown.

FIG. 1A shows a first example configuration comprising a simple box 102 with an openable lid. FIG. 1B shows a second example configuration comprising a double-layered structure 104 with two open-topped boxes connected along shared edges to a central open-topped box two layers of tile elements high. FIG. 1C shows a third example configuration comprising two open-topped boxes 106 connected together at a shared corner in a diamond configuration. FIG. 1D shows a fourth example configuration comprising four boxes 108 connected together along shared edges in a line, with the two boxes at the ends of the structure having openable lids.

These examples are merely intended to illustrate the basic concept behind the invention, and are not intended to be limiting. Much larger and more complex assemblies can be put together according to the desires of the user.

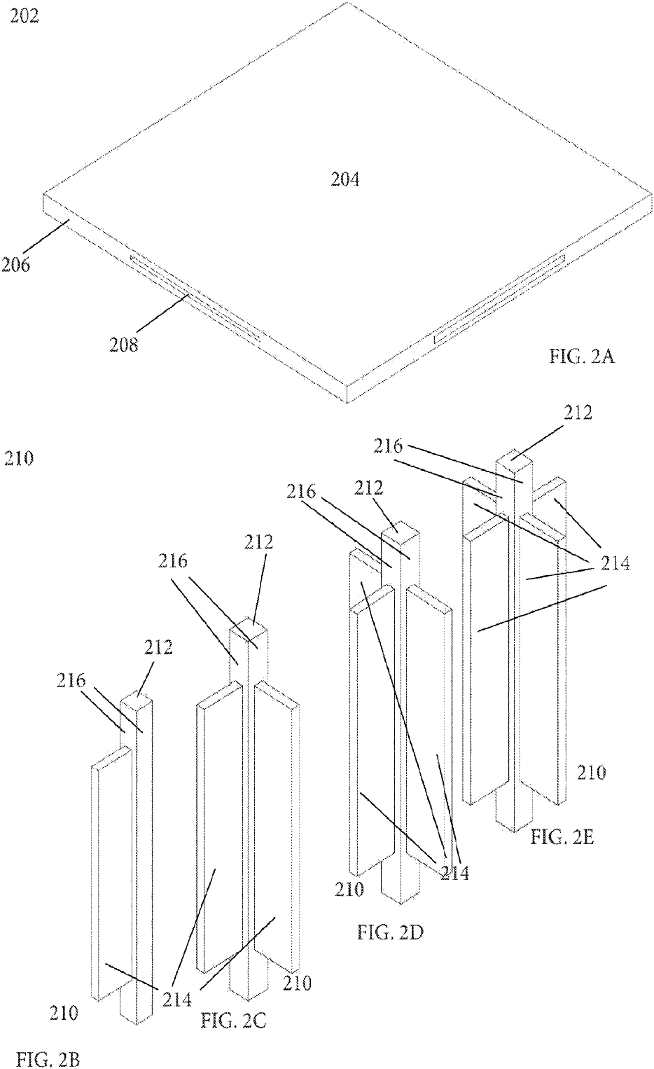

Referring to FIG. 2A–FIG. 2E, an example configuration of a set of core elements of the disclosed modular system are shown, used building the foundation structures of the above assemblies.

Referring to FIG. 2A, an example tile element 202 of the disclosed system is shown. Assemblies built using the disclosed system generally comprise two or more such tile elements connected together as described below.

Each tile element 202 forms a flat square panel 204 having four edges 206 of a first length. Each edge 206 of each tile element has disposed thereon a linear connector cavity 208 running parallel to the edge. The cavities are configured to receive a corresponding protrusion from the connector elements described below, and spans a portion of the edge 206.

FIG. 2B to FIG. 2C each show a different type of connector element 210. Each connector element 210 is formed of a square rod 212 having a length roughly equal to the edges of the tile elements 202 so that they do not overlap the tile elements and interfere with each other when larger structures are assembled.

Each connector element 210 has a protrusion 214 extending perpendicularly to the face of one or more of the four faces 216 spanning the length of the square rod 212. The Protrusions are thus always angled at 90 degree multiples from one another, allowing the formation of any kind of cuboid-type assembly while keeping the design of such assemblies simple and consistent.

The protrusions 214 span a portion of the rod 212 that matches the length of the cavities 208 in the tile elements and extend to a length that matches the depth of the cavities 208.

FIG. 2B shows a connector element 210 with protrusions on opposing faces, these are useful for connecting tile elements 202 together to from extended tile elements and also extended door elements as described below. FIG. 2C shows a connector element 210 with protrusions on adjacent faces, these can be used to connect corners of cuboids. FIG. 2D shows a connector element 210 having protrusions on three of its four faces, can be used to join two cuboids along an edge. FIG. 2E shows a connector element 210 with protrusions extending from every face, these can be used to connect four tile elements together in a cross shape.

The disclosed system may also comprise one or more openable doors if used for storage. The doors need to be integrated with the modular assembly via a hinge joint but otherwise remain free to move.

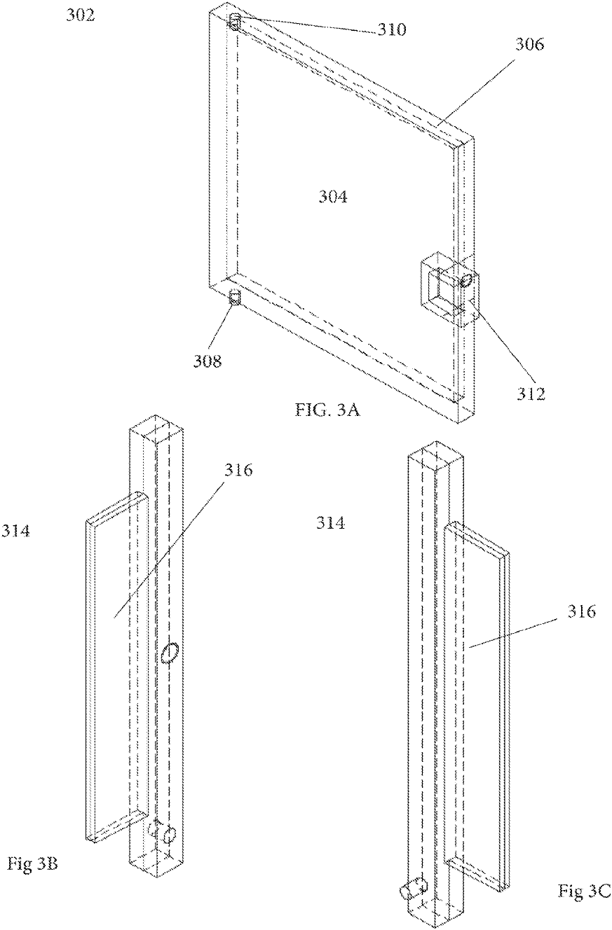

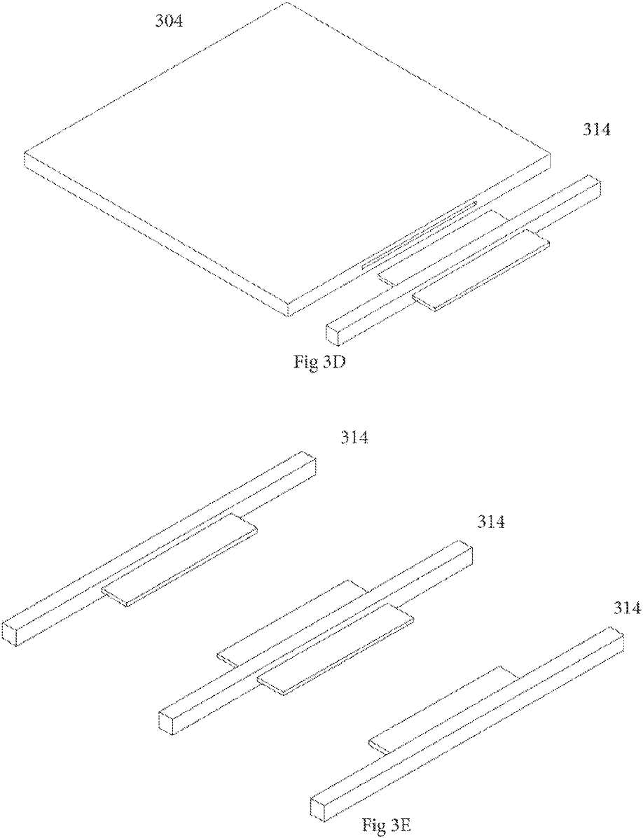

Referring to FIG. 3A an example of a door element component 302 is shown.

Each door element forms a flat panel 304 having four edges 306 of length equal to or less than the lengths of the tile elements in the system. While the door elements 302 are similar in structure to the tile elements 202, they differ in that a door element has at least one edge with no connector cavity since it needs to be able to swing freely and so does not need to connect on every edge.

To facilitate this swinging movement, a hinge protrusion 308 and/or hinge cavity 310 is disposed at the end of each edge that is adjacent to the edge having no connector cavity, i.e. the hinged side of the door element 302. Door elements can have two hinge protrusions or two hinge cavities, but in most cases they will have one of each on opposing sides so that they can easily be stacked together so as to be extendable or extended with door connectors as described below.

As shown in FIG. 3A, the door element 302 can also comprise a handle 312 or grip disposed on a planar face of the door element. These may also be accompanied by latching or locking mechanisms

Referring to FIG. 3B and FIG. 3C, the door elements 302 also require one or more modified connector elements 314 to be integrated into the assembly. Each door connector element 314 is similar to the regular connector elements in that they are formed of a square rod having the same length. However the door connector elements 314 cannot comprise four protrusions 316 like the connector of FIG. 2E, they must have one side free to allow the door to swing.

Furthermore, the face of each door connector element 314 configured to receive the door has a matching hinge protrusion 308 and/or hinge cavity 310 configured to form a hinge joint with the hinge cavity or hinge protrusion of a corresponding door element.

Preferably, the door connector elements 314 only have one or two protrusions 316, with two faces free, each having either a hinge protrusion 308 or hinge cavity 310. Door connector elements configured as such are more versatile.

As mentioned above, a regular connector element such as that shown in FIG. 2B can be used to connect two door elements together to from an extended door element, see FIG. 3D and FIG. 3E. Alternatively, the door elements can be stacked directly without connector elements to from extended door elements with no connectors where desirable.

Other modified connector elements can also be provided with the system, such as for example supporting leg connector elements which attach to the bottom or sides of tile elements on a bottom layer of cuboids of an assembled modular structure to put the finishing touch on a piece of furniture or storage solution.

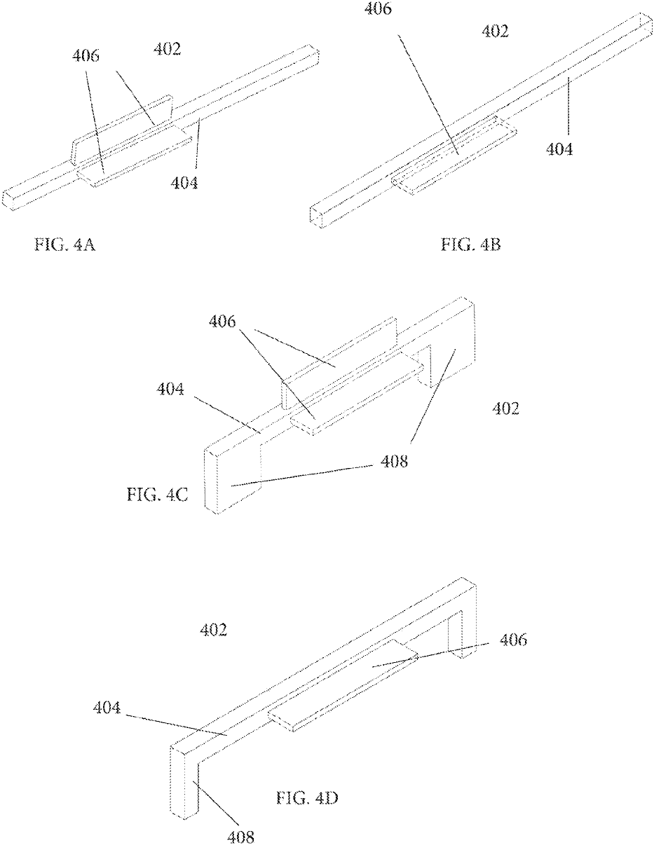

FIG. 4A to FIG. 4D provide some examples of possible configurations of such modified leg connector elements 402. They are generally of the same base structure as the regular connector elements, but with additional protrusions or length.

FIGS. 4A and 4B show support leg connector elements 402 having a square rod structure 404 which is longer than the length of the of the corresponding tile elements, with the protrusions 406 displaced away from the centre of the rod so that when they are built into a vertical side (FIG. 4B) or corner (FIG. 4A) of an assembled structure, the longer side of the rod 404 protrudes out from underneath the structure providing support as a leg.

Another example type of leg support connector 402 is shown in FIGS. 4C and 4D which is configured to provide horizontal support across the bottom of an assembled structure, where instead of being longer than and protruding from the structure, the leg connectors 402 are provided with two legs 408 that extend perpendicularly or opposite from the faces on which the normal connector protrusions 406 of the leg support connectors 402 are disposed. This allows the configuration of FIG. 4C to be built into a bottom corner of an assembly and the configuration of FIG. 4D to be built into a bottom edge of an assembly.

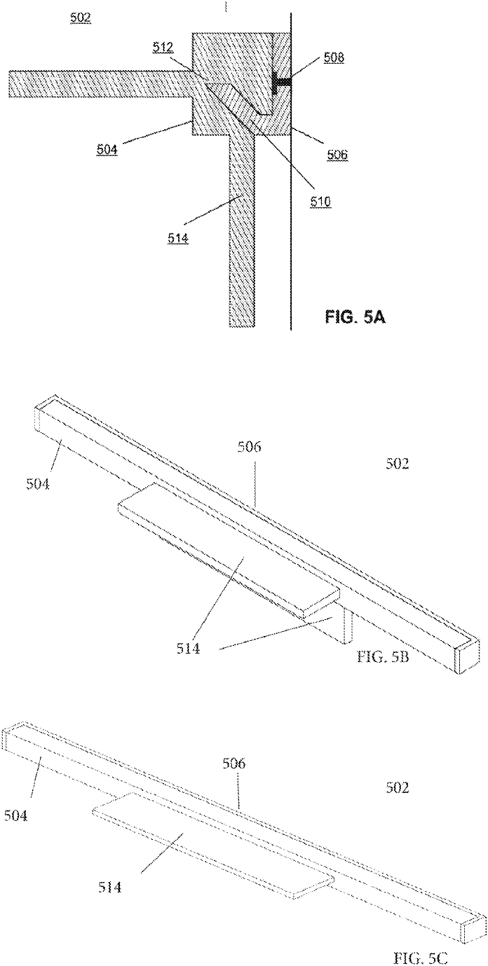

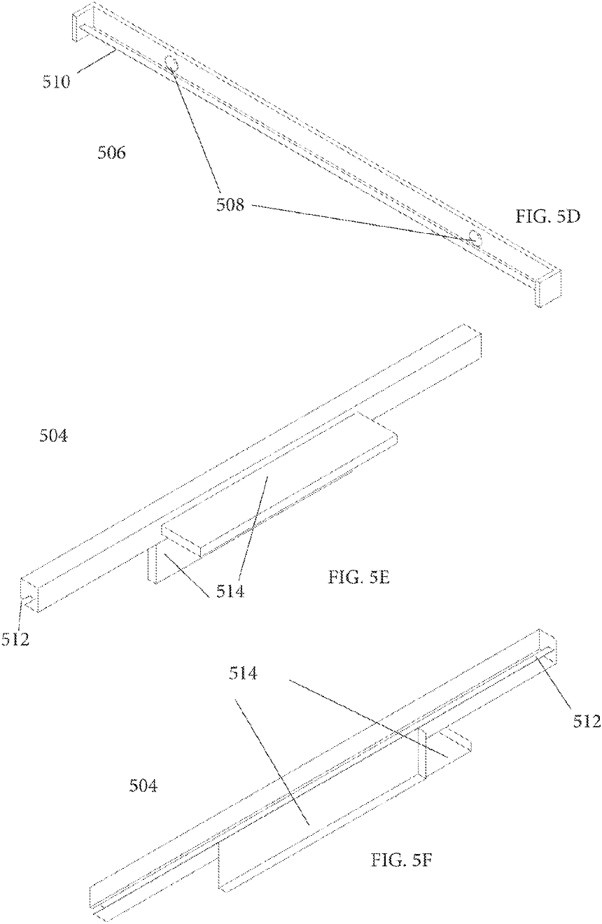

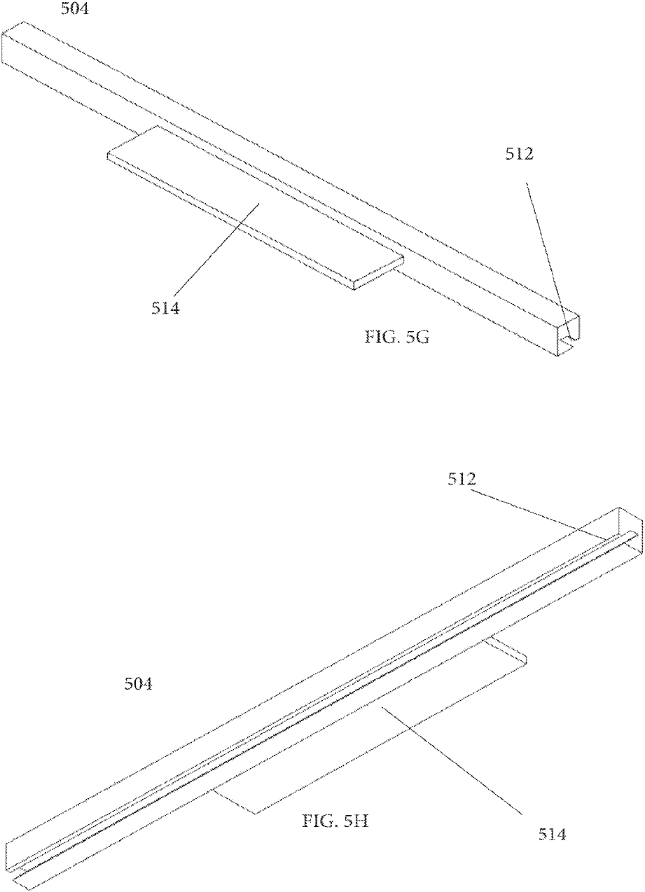

Referring to FIG. 5A to FIG. 5H, the connectors may also be modified to allow mounting of the modular assembly of cuboids onto a wall.

In order to achieve this, one or more two-part bracket connectors 502 are provided, each having an inner bracket component 504 and an outer bracket component 506. FIG. 5A shows a cross-sectional view of an example configuration of a two-part bracket connector 502 installed on a wall.

The outer bracket 506 has one or more openings 508 that allow attachment means such as a threaded screw to be driven through the outer bracket 506 and the wall to secure it there, it then provides support to the inner bracket 504 via an angled supporting shelf 510 which extends outwards and at an angle upwards to interlock with a corresponding cavity 512 of the inner bracket 504.

The inner bracket then has its own set of protrusions 514 which in turn support the modular assembly to allow it to hang on the wall. Interlocked bracket connectors are shown in FIGS. 5B and 5C, with 5B showing a top bracket and 5C showing a bottom bracket.

Generally, connector brackets which are intended to be used for a top connection will have two such protrusions, one extending outwards horizontally and one extending vertically downwards. The inner and outer brackets for top and bottom connections are shown on their own in FIGS. 5D through 5H.

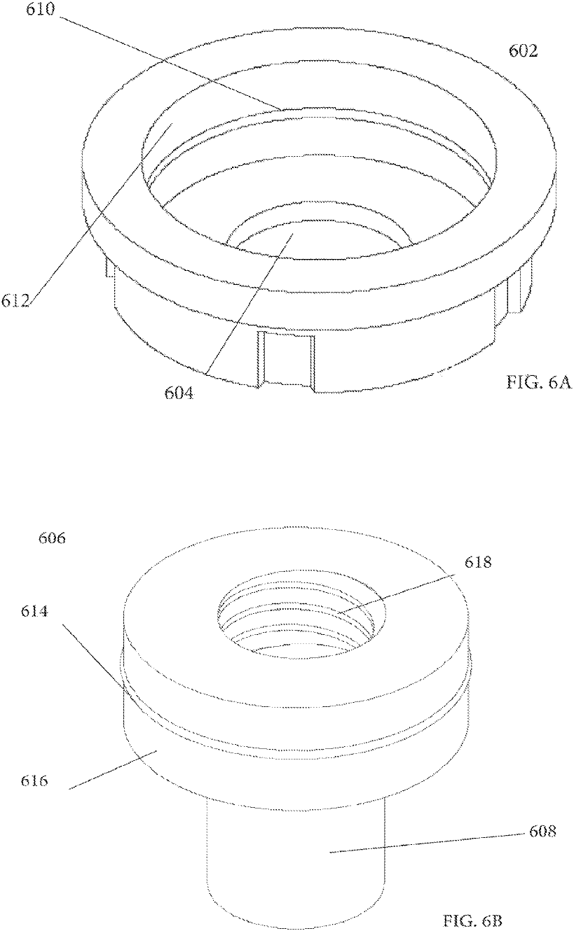

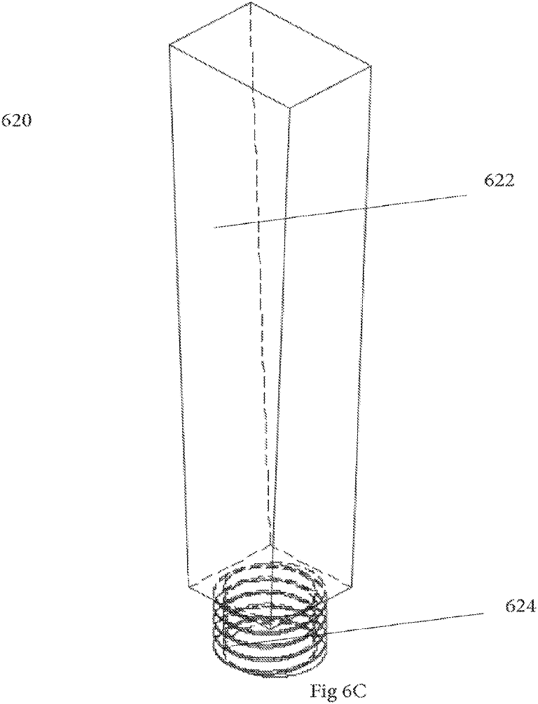

Finally, a locking system for securing the modular elements together may also be incorporated into the disclosed system. The proposed locking system exemplified by FIG. 6A and FIG. 6B is both secure and easy for a user to operate without any prior DIY knowledge or skills.

The locking system is two-part, and comprises pairs of corresponding receiving elements as shown in FIG. 6A and a locking elements as shown in FIG. 6B. The locking mechanism can be employed at any connector-cavity joint as described above for the various components.

In order to implement the locking mechanism, each tile element employing the locking mechanism must have an opening disposed along a connected edge to be locked with a connector element, and each connector element protrusion to be locked must comprise a corresponding indent or opening that aligns with the opening of the tile element when they are connected together.

The opening of the tile element is then provided with a receiving element 602 as shown in FIG. 6A. The receiving element 602 is made of rubber or plastic for its ability to change shape while retaining its form. The receiving element has its own opening 604 and a deformable interior surface formed of the rubber/plastic.

The locking mechanism further comprises one or more corresponding locking elements 606 such as that shown in FIG. 6B. The locking elements 606 are also made of rubber or plastic and comprise a protrusion 608 that slides through the opening 604 of the receiving element 602 and extends through the opening of the tile element to lock the protrusion of the connected connector element in place. Thus, once a tile element and connector element have been connected, a user can simply reach in and pop a locking element into the hole formed between the two, guided by the receiving element.

In the present example, the receiving elements 602 each comprise a groove 610 running about the circumference of an inner circular surface 612, and the one or more rubber or plastic locking elements 606 each comprise a corresponding ridge 614 about the circumference of an outer surface 616 which is configured to interlock with the groove to strengthen the connection.

The disclosed locking mechanism is particularly useful when the tile elements and connector elements are formed of wood or a wood like substance that is not deformable, since it introduces a convenient and simple solution to locking pieces in place by utilising the deformable properties of rubber to properly secure the pieces together by compression under pressure.

Ease of use for the end user can be even further improved by, as in the illustration of FIG. 6B, providing each locking element 606 with an inner threaded cavity 618 at the top, and by further providing an installation and disassembly tool 620 such as that shown in FIG. 6C for allowing a user to remove the locking elements from the receiving elements.

The user simply grips the installation and disassembly tool 620 by the handle 622 and screws the threaded end 624 of the tool into the threaded cavity 618 of the locking element 606, and then pulls, popping the locking element back out with ease for disassembly or reconfiguration of the system.

Unless otherwise defined, all terms (including technical terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The disclosed embodiments are illustrative, not restrictive. While specific configurations of the modular system have been described in a specific manner referring to the illustrated embodiments, it is understood that the present invention can be applied to a wide variety of solutions which fit within the scope and spirit of the claims. There are many alternative ways of implementing the invention.

It is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A modular system for constructing storage solutions and/or furniture, the system comprising:
two or more tile elements, each tile element forming a flat panel having four edges of a first length, wherein each edge of each tile element has disposed thereon a linear connector cavity running parallel to the edge, each cavity spanning a second length equal to a portion of the first length and having a first depth; and
one or more connector elements, each connector element being formed of a square rod having a length equal to the first length, wherein each connector element has disposed on one or more of the four faces spanning the length of the square rod a protrusion extending perpendicularly to the face, the protrusion spanning a portion of the rod equal to the second length and extending a distance from the face equal to the first depth.

2. A modular system according to claim 1, wherein the system further comprises:
one or more door elements, each door element forming a flat panel having four edges of length equal to or less than the first length, wherein each door element has at least one edge with no connector cavity disposed thereon, and has a hinge protrusion and/or hinge cavity disposed at the end of each edge that is adjacent to the edge having no connector cavity; and
one or more door connector elements, each door connector element being formed of a square rod having a length equal to the first length, wherein each door connector element has disposed on between one and three of the four faces spanning the length of the square rod a protrusion extending perpendicularly to the face, the protrusion spanning a portion of the rod equal to the second length and extending a distance from the face equal to the first depth, a fourth face of each door connector element having disposed at one end thereof a hinge protrusion and/or hinge cavity configured to from a hinge joint with the hinge cavity or hinge protrusion of a corresponding door element.

3. A modular system according to claim 2, wherein one or more door elements further comprise a handle or grip disposed on a planar face of the door element.

4. A modular system according to claim 2, wherein one or more door elements and one or more corresponding connector elements comprise corresponding latch or locking mechanisms.

5. A modular system according to claim 2, wherein each door element and door connector element comprises both a hinge protrusion on one edge and hinge cavity on an opposing face.

6. A modular system according to claim 2, wherein each door element comprises between one and three edges having disposed thereon a linear connector cavity running parallel to the edge, each cavity spanning a length equal to the second length and having depth equal to the first depth.

7. A modular system according to claim 1, further comprising one or more leg connector elements, one or more of the leg connector elements being formed of a square rod having a length greater than the first length and having disposed on one of the four faces spanning the length of the square rod a protrusion extending perpendicularly to the face, the protrusion spanning a portion of the rod equal to the second length and extending a distance from the face equal to the first depth.

8. A modular system according to claim 1, further comprising one or more leg connector elements, one or more of the leg connector elements being formed of a square rod having a length equal to or greater than the first length and having disposed on two adjacent faces of the four faces spanning the length of the square rod a protrusion extending perpendicularly to the face, each protrusion spanning a portion of the rod equal to the second length and extending a distance from the face equal to the first depth.

9. A modular system according to claim 1, further comprising one or more leg connector elements, one or more of the leg connector elements being formed of a square rod having a length equal to or greater than the first length and having disposed on two adjacent faces of the four faces spanning the length of the square rod a protrusion extending perpendicularly to the face, each protrusion spanning a portion of the rod equal to the second length and extending a distance from the face equal to the first depth, and further comprising two or more leg supports disposed on a third face of the four faces.

10. A modular system according to claim 1, the system further comprising one or more bracket connector elements, each bracket connector element being formed of:
an outer bracket having a length equal to or greater than the first length and having a supporting shelf and a back wall together forming an angled L-shaped profile, the back wall comprising one or more openings for securing the outer bracket to a wall; and
an inner bracket having a length less than or equal to the length of the outer bracket and a quadrilateral profile having an angled indent configured to interlock with the L-shaped profile via the angled supporting of the outer bracket, each inner bracket having disposed on between one and three of the four faces spanning the length of the inner bracket a protrusion extending perpendicularly to the face, the protrusion spanning a portion of the inner bracket equal to the second length and extending a distance from the face equal to the first depth.

11. A modular system according to claim 1, wherein the system further comprises a locking mechanism for securing the modular elements together, the locking mechanism comprising:
one or more first openings disposed on the one or more protrusions of the connector elements;
one or more second openings disposed at corresponding positions of the one or more tile elements so as to overlap with the one or more first openings when the connector elements are inserted in the cavities of the tile elements, the one or more second openings each having a corresponding rubber or plastic receiving element disposed therein; and
one or more rubber or plastic locking elements configured to interlock with the receiving elements and protrude through both the first and second openings of a connection between a connector element and tile element so as to lock the pieces in place.

12. A modular system according to claim 11, wherein the rubber or plastic receiving elements each comprise an groove running about the length of an inner surface and the one or more rubber or plastic locking elements each comprise a corresponding ridge about the circumference of an outer surface and configured to lock with the grooves.

13. A modular system according to claim 11, wherein the system further comprises an installation and disassembly tool comprising a handle and a threaded end; and wherein each plastic locking element comprises a threaded cavity configured to interlock with the threaded end of the installation and disassembly tool.

14. A modular system according to claim 1, wherein one or more of the tile elements and one or more of the connector elements are formed of one or more of: wood, ply, plastic, or a metal such as aluminium.

15. Use of the modular storage system of any one of claims 1 to 14 for constructing custom storage solutions.

16. Use of the modular storage system of any one of claims 1 to 14 for constructing custom furniture solutions.
